(19) United States
(12) Patent Application Publication
(10) Pub. No.: US 2002/0090416 A1
(43) Pub. Date: Jul. 11, 2002

(54) Method of enhancing absorption and utilization of protein

(76) Inventor: Philip Connolly, Lake Arrowhead, CA (US)

Correspondence Address: Paul M. Denk, 763 South New Ballas Road, St. Louis, MO, 63141, US

(21) Appl. No.: 10/045,803

(22) Filed: Jan. 12, 2002

Related U.S. Application Data
(63) Continuation-in-part of application No. 09/517,502, filed on Mar. 2, 2000.
(60) Provisional application No. 60/123,424, filed on Mar. 9, 1999.

(51) Int. Cl. A23L 1/00

(52) U.S. Cl. 426/2

(57) ABSTRACT

A method of enhancing protein absorption and utilization from the gastrointestinal tract of a subject requiring such enhanced protein absorption and utilization including the oral administration of milk protein concentrate incorporating probiotic bacteria to enhance metabolic processing from the gastrointestinal tract and utilization in the body, and such probiotic organisms preferably include bifido bacteria combined with acidophilus bacteria or other lactic acid producing bacteria.

### BACKGROUND OF THE INVENTION

The sports nutrition field currently is the most demanding of applications for proteins. Serious athletes and body builders spend large amounts of money on chemicals and proteins in an effort to lower their overall body fat content while increasing their lean tissue (muscle) mass. Serious body builders spend significant amounts of money per day, and per month, just on protein purchases. When they spend that kind of money on protein products, they really do care about how well their body is utilizing the protein to make muscle tissue. The alternative to utilizing this type of a protein product to enhance muscle tissue is the use of illegal or dangerous drugs to increase the efficient metabolism of the protein, and its generation of muscle tissue.

There are two parts to human metabolism, anabolic metabolism (anabolism), or the building of a body, and catabolic metabolism (catabolism), or the tearing down of the body. On a daily basis, the average body is going through constant cycles of building up and tearing down. During the immediate post-workout or post-exercise period, the body is in a catabolic mode. However, exercise usually activates certain anabolic switches in the body and the body then begins to build over what the exercise destroys. The body even builds a little more than what is destroyed and that is why exercise is anabolic. Events like stress or illness are catabolic. The body's immune system is powdered by glycogen, which is stored in muscle tissue.

When the body is under stress or illness, it starts tearing down muscle tissue to get at the glycogen. Long bouts with stress or illness can nullify years of hard exercise and clean living. In theory, if one can skew the body's metabolism significantly towards the anabolic side, then the body will be building much faster than it is tearing down and one can grow bigger muscles. Consequently, sports nutritionists have concentrated on developing protein powders or supplements in an effort to promote good health, i.e., good health is skewed towards anabolism.

The current practices of protein supplementation can be self-defeating. People on a high protein diet usually adopt such a diet because they want to gain muscle tissue or mass. However, people on high protein diets usually suffer from degraded digestive systems and, as a result, experience poor absorption of the nutrients they do consume, including protein. People who consume large quantities of proteins often metabolize the protein in the liver and utilize the protein for energy rather than making muscle tissue. A byproduct of such protein metabolism is the accumulation of nitrogenous compounds, such as ammonia and urea, in the intestines. These byproducts can be deleterious to the intestines, such as deterioration of the intestinal lining, and to overall health. Overtime, these people absorb less and less protein. People on high protein diets can suffer ill health and deterioration of their muscles to fight illness.

Proteins are such large molecules that the body can only digest and utilize a portion of the protein that is consumed for manufacture of muscle and the remainder of the protein is utilized for energy or is simply expelled from the body. It is commonly known that a protein that would be used in a highly efficient manner for the body, i.e., the highest percentage of protein consumed that would be used to make muscle tissue, would be in high demand by serious athletes and body builders. There is major disagreement in the sports nutrition industry about which proteins will provide the greatest gain in muscle tissue per gram consumed. Some marketers have decided, instead, to focus on improving the digestive system in the customers to help with milk protein utilization. Marketers and consumers alike are well aware that improved digestion will help with better absorption of protein into the body. To date, people have tried “predigesting” proteins to make them more easily digested by the body and, thus, more efficiently absorbed into the cells.

Other companies have tried adding digestive aids, such as enzyme mixes, into their protein powders, and have tried to convince their customers that these aids will help with providing maximum protein absorption into the body. Still others add the amino acid glutamine to their preparations, because glutamine is known to assist in maintaining healthy intestinal linings thereby helping with protein absorption. Everyone, however, continues to search for some new method to insure that their customers gain the maximum amount of muscle from the protein they consume.

### SUMMARY OF THE INVENTION

The current invention uses a milk protein, or any of the other related proteins, which are fortified or cultured with a probiotic bacteria or combination of several probiotic bacteria, in the sports nutrition area to enhance protein absorption from the gastrointestinal tract, and thereby increase strength, muscle development, resistance to disease to and enhance physical and strength qualities of the consumer. The product is particularly useful to enhance protein absorption and utilization from a high protein diet.

The current invention also relates to the production of a milk protein concentrate, and an improved method for manufacturing the same, for application in the sports field. The concept of the invention is the oral administration of a high quality milk protein concentrate with an added property to it, which is more efficiently used in the body.

The current invention provides for the oral administration of a milk protein concentrate, i.e., the milk protein of skim milk that has been concentrated to a higher percentage of protein than would be found in skim milk, by removal of undesired milk constituents, such as lactose, ash, and fat. The protein concentrate can run from 65% to 90%, depending on the process used to make the milk protein. The protein concentrates are combined with probiotic bacteria to enhance absorption and utiliation of the proteins. The probiotic organism are provided in a total organism count that reaches about 100,000 to about 500,000 organisms per gram of skim milk protein concentrate. The preferred probiotic bacteria include bifido bacterium, acidophilus, and yogurt culture bacteria.

Thus, the current invention is directed to a method of production and administration of an improved performance milk protein concentrate that is not only effective, but properly fits into the body metabolism function, in order to maximize and obtain the most efficient production of protein, that can generate healthy muscle tissue. The concept of this current invention is to utilize the high quality milk protein concentrate, and add a new property to it so the product can make it even more efficient when metabolized by the body. Hence, this process utilizes the high quality milk protein concentrate, which has added to it a probiotic organism, generally in the form of a bifido bacterium, acidophilus, and yogurt culture bacteria. These bacteria are considered to be the most important intestinal bacteria for humans, and are thus classified as probiotic, which are good for living organisms in the human being. One gram of milk protein concentrate, having these ingredients added to it, can contain over a million viable probiotic organisms. One advantage of the invention is to provide a method of enhancing protein absorption from the gastrointestinal tract of a subject consuming the protein.

The current invention contemplates utilizing the milk protein concentrate which has been fortified with these beneficial organisms to improve the overall digestive health of the consumer while providing the basic building blocks for muscle tissue, such as amino acids. The product can be used to enhance absorption and utilization of proteins in a high-protein diet. The net effect from consuming such a cultured protein should be improved health, a higher daily degree of anabolism with respect to catabolism, and a larger net gain in lean body tissue. The serious athlete or body builder should see better results in gaining muscles and will feel better in the long run.

Another advantage of the invention is to provide for enhanced metabolic use of protein by a subject consuming the protein by enhancing the absorption of the protein from the gastrointestinal tract of the subject.

Another advantage of the invention is to provide for enhanced absorption and metabolic use of protein by a subject consuming the protein by administering to the subject a protein supplement including probiotic organisms to enhance the absorption and utilization of the protein contained in the supplement.

Another advantage of this invention is to provide a new process with enhanced ingredients for manufacture of such a protein supplement.

Another advantage of this current invention is to use a milk protein concentrate or isolate powder that has been cultured with various enzymatic organisms for use in application in the sports nutrition field.

Another advantage is to provide a correct balance of probiotic organisms in the consumer's intestines that will actually improve the health and strength of the consumer.

A further object of this invention is to provide a protein supplement that is more efficient in its digestion of the food eaten.

Another object of this invention is to provide a protein supplement that is more efficiently absorbed, and provides enhanced utilization as a food nutrient.

A further object of this invention is to provide a protein supplement that generates better overall health.

Another advantage of this invention is the provision of a high protein supplement that does not have a deleterious effect on intestinal lining.

Yet another object of this invention is to provide for the serious athlete and body builder a higher ratio of anabolism compared to catabolism.

Still another object of this invention is to provide more muscle tissue growth for the serious athlete.

Yet another object of this invention is to provide for the athlete and body builder less harmful side effects from consuming high quantities of protein.

Still another object of this invention is to provide method of enhancing protein utilization in a subject by providing an oral protein supplement that is cultured to achieve a gaining of amino acids from the probiotic type of bacteria that is not consumed as a meat or conventional dietary supplement.

Still another object of this invention is to provide for more efficient utilization of protein per gram when consumed.

These and other objects and advantages of the method of the present invention will become apparent from the description of the preferred embodiment, which follows.

### DESCRIPTION OF THE PREFERRED EMBODIMENT

One preferred embodiment of the present invention provides for the oral administration of high quality milk protein combined with probiotic bacteria to enhance absorption and utilization of the protein. Generally, the method of enhancing protein absorption and utilization includes the consumption of any appreciable amount of the combination in association with other protein sources until the total dietary protein intake approaches approximately 1.5 grams to about 2.0 grams of the high quality protein per kilogram of body weight per day.

The milk protein used in the method of the present invention possesses a high quality amino acid profile. The bioactivity of the protein fractions themselves have been shown to trigger anabolic activity when consumed. Some of the protein fractions and peptide sequences have been shown in studies to actually help boost the human body immune system. The protein supplement of this invention is probiotic, meaning supporting (or improving) life, in that it contains a component, or components, that have been shown to actually improve a bodily function when that component is introduced into the body. The current invention comprises administration of a protein milk concentrate having enzymatic organisms in such quantities that the counts of these organisms total from 100,00 to as much as 50,000,000 viable organisms per gram of concentrate powder.

In the preferred embodiment, the probiotic types of organisms that can enhance protein in metabolism are those bacteria that are naturally found and/or thrive in the intestines of the human body, and that also provide beneficial health effects in the human. Examples of preferred organisms are bifido bacteria, acidophilus bacteria, and lactic acid producing bacteria. Bifido bacterium, also sometimes called bifidus, is the most commonly known probiotic organism. Two bacteria commonly known as yogurt cultures are other examples of acceptable probiotic type of bacteria. Acidophilus has also been shown to provide certain benefits to human beings and is considered to be enhancing or protein metabolism, and represents another preferred organism included in the enhanced protein supplement employed in the method of the present invention.

Bifidus is a native bacterium in the human intestinal system. In fact, it is commonly accepted that one cannot have too much bifidus in the intestine. High intestinal bifidus counts have been associated with good health. Bifidus, however, can be easily destroyed by the foods we eat or by other bacteria, yeast and molds. When the bacterial counts in our intestines become skewed towards large numbers of yeast, molds, coliforms, etc., we begin to build up toxins in our intestines.

Bifido bacteria feeds on oligosaccharides. Oligosacchrides are considered favorable to biotic production because they help to maintain large numbers of bifido bacteria in the intestines. However, oligosaccharides are carbohydrates, and carbohydrates are not always desired in the sports nutrition and general good health fields because they are known to generate gas in the intestines. So, if one doesn't wish to consume daily quantities of oligosaccharides then one needs to actually consume live, viable protein digesting enhancing organisms on a daily basis in an effort to maintain healthy counts of organisms in the intestine.

Yogurt organisms thrive in the human intestine. Yogurt organisms multiply much faster than yeast and molds and can actually choke out the yeast and molds as they multiply by creating metaoblic by-products of their own that eventually destroy yeast and molds. Some studies have shown that consuming yogurt on a daily basis leads to lower intestinal yeast and mold counts. Coliforms, which are considered to be harmful to humans, such as E.coli, and others, are also depleted out of the system by the yogurt and other lactic acid producing organisms. Lactobacillus bulgaricus and streptococcus thermophilus are the most common form of yogurt organisms

Acidophilus also thrives in the human intestines. Acidophilus multiplies extremely fast, and will, again, choke out the other, harmful organisms that are introduced into our intestines on a daily basis. Acidophilus has not been found to do any harm to the humans, and by virtue of destroying the harmful bacteria, actually helps to maintain good health in humans. They also can actually choke out harmful organisms in the intestines which can generate toxins that are absorbed by the body. Such harmful organisms include yeast, mold, coliforms, and gram negative bacteria.

Other preferred probiotic bacteria such as lactic acid producing organisms are beneficial in the method of the present invention. These include lactobacilius plantarum. Streptococcus thermophilus, Lactobacillus bulgaricus and Lactobacillus Acidophilus. They can also choke out deleterious organisms. By choking out the harmful organisms, beneficial organisms such as Bifido can proliferate.

Therefore, a preferred embodiment of the present invention includes the administration of high quality milk proteins supplemented with bifidus longum in combination with Lactobacillus bulgaricus and streptococcus thermophilus, which are the most common form of yogurt organisms, and Lactobacillus acidophilus. However, the invention may utilize any combination of probiotic organisms added to the milk protein. The milk protein concentrate can be made with any one individual of the above organisms, or any combination of one or more of such organisms, or even utilize other probiotic organisms like Lactobacillus plantarium.

A preferred embodiment of the invention includes the bifidus, Lactobacillus bulgaricus streptococcus thermophilus, and Lactobacillus acidophilus organisms are selected for the initial product because of their benefits to human beings and these organisms are compatible with each other and can thrive simultaneously in the intestine. The yogurt organisms and acidophilus multiply fast in the intestines. As they multiply, they produce lactic acid as a metabolic by-product. Some studies have indicated that lactic acid producing bacteria can help to prevent colon cancer, and it is thought that perhaps they do so by cleaning up the toxins from the colon. In addition, these lactic acid producing bacteria also produce enzymes as metabolic by-products which can be used by the human host for digestion, absorption of proteins, fats, and complex carbohydrates. Bifidus bacteria are the main digestive force in the intestines. They aid more efficient digestion/absorption by actually consuming toxins and producing beneficial metabolic by-products.

The probiotic organisms help repair and maintain healthy intestinal linings. They do this by first scavenging the potentially harmful nitrogenous compound by-products that collect in the intestines. They consume these compounds, removing them from contact with the intestinal lining and thereby prevent degradation of the intestinal lining. Also, they use the nitrogen to make new amino acids which can be reabsorbed from the intestines and used to make muscle tissue.

Probiotic colonic organisms will actually utilize the harmful urea collected in the colon from bodily protein metabolism to synthesize new amino acids. This synthesis provides two benefits. First, the harmful colonic urea content, from consumption of abnormally large quantities of protein, is reduced. Secondly, the probiotic bacteria manufacture amino acids from the urea. These amino acids include the essential amino acids needed by every human being and the specific amino acids desired by athletes and body builders. Studies have shown that the amino acids synthesized by the probiotic bacteria are then absorbed into the host body to be utilized to the benefit of the consumer.

In general the consumption of probiotic bacteria should result in the following benefits:

1. more efficient digestion of eaten foods

2. more efficient absorption and utilization of food nutrients

3. better over all health

4. higher ratio of anabolism as compared to catabolism

5. increased muscle tissue growth

6. less harmful side effects from consuming large quantities of protein

7. increasing amino acid production in the intestinal tract

8. more efficient utilization per gram of protein consumed.

Benefits 4 through 8 are of particular interest to serious athletes and bodybuilders.

An example of the ingredient listing for production of probiotic milk protein concentrate employed in the methods of the present invention includes the following ingredients:

### EXAMPLE

Milk protein concentrate: 65% to 90%

One or more of the following enzymatic organisms:

A. Bifido Bacteria—0.01% to 1%

B. Acidophilus Bacteria—0.01% to 1%

C. Lactic Acid Producing Bacteria—0.01% to 1%

a. Lactobacillus Bulgarious

b. Streptococcus Thermophilus

c. Lactobacillus,Acidophilus

One or more of the foregoing enzymatic bacterium are used and intermixed with the milk protein concentrate powder. This is simply achieved by the routine mixing process, since the enzymatic organisms, also identified above, can be obtained in the powdered form. The ingredients are simply mixed until their diffusion is thorough within the powdered concentrate, and then can be packaged ready for shipment, marketing, and consumption.

The process for producing the enhanced protein producted used in this particular invention commences with the actual culturing of the organisms used in this procedure for producing milk protein concentrate. Cheese is usually the starter culture, within tanks, or a yogurt starter culture tank is employed, and the organisms are grown. A base medium, such as food and nutrients, of permeate from an ultrafilitration process is combined with the hydrolyzed milk peptones, to feed the organisms while they grow. Then a fluid skim milk is processed through a filtering membrane to separate out the lactose, ash, and other undesirable milk constituents while concentrating the skim milk protein to higher levels by standard industry processing practices.

When the desired protein content of 65% to 90% protein is reached, the ultrafiltration is then ceased, and then, in the fluid state, the milk protein concentrate (MPC) is inoculated with the organism cultures to a desired total organism count level of 100,000 to 50,000,000 per gram of the MPC solids. The cultures can get as high as 100,000,000 organisms per gram, so one only needs to add 10% or less, of the concentrated organism cultures to get the desired counts. Then one spray dries the fluid inoculated concentrate under a gentle, low heat condition, to protect the organisms, and turn it into a powder.

Another and more facile way to process the milk protein concentrate, is to start with an existing milk protein concentrate powder, having a protein content of 65% to 95%. The powder is then placed into a mixer, such as a ribbon blender, V blender, etc., and a powdered preparation of the various organisms is then applied and added thereto. The freeze-dried powdered preparations of the various organisms are available from sources. These powdered preparations contain organism counts as high as 100,000,000 per gram. One then adds the proper amount of each powdered preparation to the milk protein concentrate powder in the blender and the two are mixed together until homogenous. If one wants to make a milk protein concentrate powder, with a count of 10,000,000 per gram, one needs to add 10 grams of the freeze-dried organism powder to 90 grams of the milk protein concentrate. To obtain a final product with a count of 1,000,000 per gram, one only needs to add 1 gram of the organism concentrate powder to 99 grams of the milk protein concentrate.

Other probiotic organisms, that may be used in the processing of this invention, include the following organisms:

Lactobacillus plantarum

Lactobacillus helveticus

Lactobacillus paracasel

Bifidobacterium bifidum

Bifidobacterium infantis

Bifidobacterium animalis

These are examples of the type of probiotic organisms available for usage in the processing of this milk protein concentrate. Other lactic acid producing bacteria, or any of the bifidobacterium, may be used for this purpose.

The powdered preparation can be mixed in any appropriate liquid medium, such as milk, water, juice and so forth, and consumed in any amount. The amount consumed, when combined with other protein sources, usually adds up to a general daily amount of protein not to exceed about 1.5 grams to about 2.0 grams of total protein per kilogram per body weight per day to enhance protein absorption and utilization and to enhance the overall health of the consumer.

Variation and modifications to the subject matter of this invention, and its method of processing, may become readily apparent to those skilled in the art upon reviewing the disclosure as provided herein. An explanation of this invention, as set forth in the disclosure, and any variations or modifications thereto, are intended to be encompassed by the scope of the invention as provided. The description of the preferred embodiment, and the example as set forth, is furnished for illustrative purposes only.

1. A method of enhancing protein absorption and utilization from the gastrointestinal tract of a subject in need of such enhanced protein absorption and utilization comprising the oral administration of a combination of milk protein concentrates and probiotic bacteria.

2. The method of claim 1 wherein the probiotic bacteria is selected from the group consisiting of bifido bacteria, Lactobacillus plantarum. Lactobacillus helveticus, Lactobacillus paracasel, lactobacillus bulgaricus, streptococcus thermophilus and combinations thereof.

3. The method of claim 1 wherein the probiotic bacteria consists of bifidus longum combined with lactobacillus bulgaricus and streptococcus thermophilus.

4. The method of claim 1 wherein the combining milk protein concentrate has a protein content of about 65% to about 90%.

5. The method of claim 5 wherein the probiotic organism is present in a total organism count of about 100,000 to about 50,000,000 organisms per gram of milk protein concentrate.

6. The method of claim 1 wherein the combination of milk protein concentrates and probiotic bacteria is administered in an amount wherein when combined with the subject's diet, a total daily consumption of protein by the subject does not exceed approximately 1.5 grams to approximately 4.0 grams of protein per kilogram of body weight per day.

7. A method of enhancing protein utilization aborption in a subject on a high protein diet comprising the oral administration of comprising the oral administration of combination of milk protein concentrates and probiotic bacteria selected from the group consisiting of bifido bacteria, Lactobacillus plantarum. Lactobacillus helveticus, Lactobacillus paracasel, lactobacillus bulgaricus, streptococcus thermophilus and combinations thereof.

8. The method of claim 7 wherein the probiotic bacteria consists of bifidus longum combined with lactobacillus bulgaricus, streptococcus thermophilus.

9. The method of claim 8 wherein the combination of milk protein concentrates and probiotic bacteria is administered in an amount wherein the subjects total daily intake of protein does not exceed approximately 1.5 grams to approximately 4.0 grams of protein per kilogram of body weight per day from both the high protein diet and the combination of milk protein concentrations and probiotic bacteria.

10. A method of promoting higher ratio of anabolism as compared to catabolism, increasing muscle tissue growth, reducing harmful side effects from consuming large quantities of protein, increasing amino acid production in the intestinal tract in an athlete and more efficiently utilizing each gram of protein consumed by the athlete comprising the consumption by the athlete of a combination of milk protein concentrates and probiotic bacteria selected from the group of probiotic bacteria consisiting of bifido bacteria, Lactobacillus plantarum. Lactobacillus helveticus, Lactobacillus paracasel, lactobacillus bulgaricus, streptococcus thermophilus and combinations thereof.

11. A process for producing an improved probiotic protein concentrate comprising the steps of:
providing a probiotic organism culture, the culture containing Bifido bacteria and lactic acid producing bacteria;
filtering skim milk fluid by passing the skim milk through a filtering membrane to separate out non-protein constituents of the skim milk;
discontinuing the filtering of the skim milk when the skim milk protein content is about 65% to about 90% of the milk, thereby generating a skim milk protein concentrate; and
inoculating the skim milk protein concentrate with the probiotic organism cultures until a total organism count reaches about 100,000 to about 500,000 organisms per gram of skim milk protein concentrate.

12. The process according to claim 11 wherein the lactic acid producing bacteria is chosen from the group consisting of Lactobacillus plantarum. Lactobacillus helveticus, Lactobacillus paracasel, and combinations thereof.

13. The process according to claim 11 wherein the step of providing probiotic organisms includes introducing a starter culture containing said probiotic organisms into a tank to produce hydrolyzed milk peptones; and
feeding the probiotic organisms with a base medium to grow the probiotic organisms, the base medium comprising food and nutrients which are combined with hydrolyzed milk peptones.

14. The process according to claim 11 including the step of converting the inoculated skim milk protein concentrate from a fluid to a powder by spray drying the fluid inoculated milk protein concentrate.

15. A process for producing probiotic protein concentrate comprising the steps of:
combining a powder form of skim milk having a skim milk protein content of about 65% to about 90% with with freeze-dried powder forms of probiotic organism culture until a total organism count within the combined powder reaches about 100,000 to about 50,000,000 organisms per gram of skim milk protein concentrate, said organism culture containing Bifidio bacteria and lactic acid producing bacteria; and
mixing the powdered skim milk protein concentrate with the powdered probiotic organism culture until the comined powder is homogenous.

16. The process according to claim 13 wherein the lactic acid producing bacteria is chosen from the group consisting of Lactobacillus plantarum. Lactobacillus helveticus, Lactobacillus paracasel, and combinations thereof.

17. A probiotic milk protein concentrate including the following ingredients by percentage of weight, of the concentrate including:
Milk having a milk protein concentrate of 65% to 90%; and
probiotic organisms in an amount of 100,000 to 50,000,000 organisms per gram of milk protein concentrate; said probiotic organisms including:
A. Bifido Bacteria—0.01% to 1%
B. Acidophilus Bacteria—0.01% to 1%; and
C. 0.01% to 1% of a Lactic Acid Producing Bacteria chosen from the group consisting essentially of
c. Lactobacillus Acidophilus
mixing said ingredients until their diffusion is thoroughly achieved within the powdered concentrate.

18. The probiotic milk protein concentrate of claim 5, and wherein one or more of the following probiotic organisms may be added to the concentrate by weight of 0.1% to 1%:
A. Lactobacillus plantarum
B. Lactobacillus helveticus
C. Lactobacillus paracasel
D. Bifidobacterium bifidum
E. Bifidobacterium infantis
F. Bifidobacterium animalis
